(19) United States
(12) Patent Application Publication
(10) Pub. No.: US 2009/0065714 A1
(43) Pub. Date: Mar. 12, 2009

(54) ELETROFLUID COLLISIONAL ACCELERATOR AND FUSION REACTOR

(76) Inventor: John P. Keady, Boca Raton, FL (US)

Correspondence Address: DR. JOHN P. KEADY, 8138 CRESTRIDGE RD., FAIRFAX STATION, VA, 22039, US

(21) Appl. No.: 11/948,975

(22) Filed: Nov. 30, 2007

Related U.S. Application Data
(60) Provisional application No. 60/868,074, filed on Nov. 30, 2006.

(51) Int. Cl. G01J 1/00

(52) U.S. Cl. 250/503.1

(57) ABSTRACT

At least one exemplary embodiment is directed toward accelerating charged hydrogenated fluid into collisions of sufficient energy to initiate at least partial fusion of the collisional hydrogenated fluid, where one of the products of the collision is a product including an element higher in the periodic tables than at least one of the colliding fluids, and where, optionally, the at least partial fusion heats a coolant loop which in turn generates electricity.

### CROSS-REFERENCE TO RELATED APPLICATIONS

This application claims a priority benefit of U.S. provisional patent application 60/868,074 filed on 30 Nov. 2006, incorporated herein by reference in it's entirety.

### FIELD OF THE INVENTION

The invention relates in general to devices and methods of electrofluid technology, and particularly though not exclusively, is related to electrofluid fusion systems.

### BACKGROUND OF THE INVENTION

In 1988 Dr. Keady developed one of the first co-axial electrofluid devices, which charged droplets of water and kerosene, and deflected the droplets in an electric field. Electrified fluid can impact many future industries, propulsion, detector designs, manufacturing, optics, power generation and transfer, shielding, nanotechnology, and semiconductor structure formation, to mention just a few. The system was described at a NASA Langley conference in 1988 as a student paper and presentation.

### Charged Fluid Technology

Plasma physicist sometimes refer to a charged fluid, when discussing some forms of plasmas. However, they are typically not discussing a true charged fluid (e.g., charged molten metal or charged water with impurities). Charged droplets have been used in coating devices. For example, in electrostatic coating, the fluid is atomized, then negatively charged. The part to be coated is electrically neutral, making the part positive with respect to the negative coating droplets. The coating particles are attracted to the surface and held there by the charge differential until cured.

With an electrostatic spray gun, the droplets pick up the charge from an electrically charged electrode near but not part of the tip of the gun. The charged fluid is given its initial momentum from the fluid pressure/air pressure combination. The use of electrospray systems requires all electrically conductive materials near the spray area such as the material supply, containers, and spray equipment to be grounded to prevent static buildup. All equipment (e.g., hangers, conveyors) must be kept clean to ensure conductivity to ground. On any ungrounded surfaces, charges will build up and any contact with an operator will ground out these surfaces, and thus the operator may receive a severe electrostatic shock.

Charging a fluid can be facilitated by adding an electrolyte. An electrolyte is a substance (usually a fluid) which has movable ions (electrically charged molecules or toms) dissolved in it which make it electrically conductive, and which allow it to undergo electrolysis. An electrolyte may be a solution, a liquid compound or a solid (e.g., cations, anions, mono-substituted imidazoliums, di-substituted imidazoliums, tri-substituted imidazoliums, substituted pyridiniums, substituted pyrrolidiniums, tetraalkyl phosphoniums, tetraalkyl ammoniums, guanidiniums, uroniums, thiouroniums, alkyl sulfates and sulfonates, halides, amides and imides, tosylates, borates, phosphates, antimonates, carboxylates, and other substances as known by one of ordinary skill in the relevant arts and equivalents, for example similar compounds as listed in Merck's™ “Ionic Liquids”, May 2005).

### The Spray Stability Problem

(From U.S. Pub. No. 2004-0226279, by Fenn. Filed 13 May 2003)

Microscopic examination of a stable electrospray shows that the liquid emerging from the tip of the spray needle forms a conical meniscus known as a Taylor cone in honor of G. I. Taylor whose theoretical analysis predicted that a dielectric liquid in a high electric field would take such a shape [G. I. Taylor, Proc. Roy. Soc. A 280, 383 (1964)]. In the case of conducting liquids a fine filament or jet of liquid emerges from the cone tip. An interaction between surface tension and viscosity, also first analyzed by Rayleigh, produces so-called varicose waves along the jet surface [Rayleigh, The Theory of Sound, Vol II. Chap. XX (Dover, N.Y. (1945]. Those waves grow in magnitude to the point where they pinch off segments of the filament having a uniform length. Surface tension transforms each such segment into a spherical droplet. The net result is a stream of droplets of uniform size with diameters slightly larger than the diameter of the jet. Because all the droplets have a net charge of the same polarity, Coulomb repulsion disperses their trajectories into a conical array. Sprays produced under these circumstances are often known as “conejet” sprays.

It turns out that to obtain a stable conejet electrospray one can achieve and maintain an optimum balance between liquid flow rate and the applied field. Moreover that optimum balance depends very strongly on the properties of the liquid, in particular its electrical conductivity, surface tension and viscosity. In general, the higher the conductivity and surface tension, the lower must be the flow rate. Introduction of liquid at a desired rate is usually achieved either with a positive displacement pump or by pressurizing a reservoir of the sample liquid with gas. In the latter case the conduit from the reservoir to the spray tip must be long enough and narrow enough to require a high pressure difference between the source and the exit of the spray needle to maintain a steady flow into the Taylor Cone at the end of the conduit. If that pressure difference is very high relative to the pressure at the needle exit, minor pressure fluctuations at the needle tip or in the ES chamber will not appreciably affect the liquid flow rate. Thus a stable steady flow can usually be maintained for a particular liquid by appropriate choice of reservoir gas pressure. In the case of a positive displacement pump, of course, the liquid flow rate can be maintained at any value for which flow rate and liquid properties are consistent with stability.

Whether it is achieved by a pump or pressurized gas, or by any other means, the flow rate required for stability can be prescribed apriori and a control system can be provided that can maintain the flow rate at the prescribed value. Because the level of thrust from a single spray element is inevitably small, it is very likely that any one vehicle can require a multiplicity of spray elements to provide the variability in magnitude and direction of thrust that may be required.

### Fusion Systems

Typically fusion calculations obtain the temperature (i.e., the kinetic energy) requirements to bring two nuclei together to fuse assuming that each nuclei has a net charge and that the kinetic energy matches the Coulomb force. For example the radius of a deuterium atom is roughly 1.5 fm (femtometer=1×10̂-15 m) and the radius of tritium is roughly 1.7 fm. Thus the temperature for fusion will be approximately equal to the temperature needed to overcome the Coloumb force between two positive nuclei and bring them within 3.2 fm. This relationship can be expressed as:

$$2 K . E . \approx k \frac{{e}^{2}}{( {r}_{d} + {r}_{t} )} \approx 0.45 MeV \qquad ( 1 )$$

Where K.E. is the kinetic energy of both nuclei. The temperature of each nuclei can be solved using it's average kinetic energy (half that calculated in (1)):

$$\begin{matrix}\frac{3}{2} kT = 0.22 MeV \to T \\ = \frac{2 K . {E}_{nuclei}}{3 k} \\ = \frac{2 ( 0.22 MeV ) ( 1.6 \times {10}^{- 13} J \text{/} MeV )}{3 ( 1.38 \times {10}^{- 23} J \text{/} K )}\end{matrix} \qquad ( 2 )$$

Thus a kinetic energy establish via acceleration across 220,000 Volt potential is needed in the simplified analysis. The high temperature has led to the formation of the field of plasma fusion, where physicists are attempting to increase the plasma density and temperature to levels needed to sustain fusion. A certain density is needed for a certain period of time to maintain a steady level of collisions to sustain ignition. J. D. Lawson showed that the product of the ion density n and the confinement time t_{c} should be above a certain level to produce ignition. The relationship can be expressed as:

nt_{c}≧3×10²⁰ s/m³ (3)

In conventional fusion systems the density is either to low, or the temperature not high enough, or the confinement time not high enough.

### SUMMARY OF THE INVENTION

At least one exemplary embodiment is directed toward accelerating charged hydrogenated fluid into collisions of sufficient energy to initiate at least partial fusion of the collisional hydrogenated fluid, where the at least partial fusion heats a coolant loop, which in turn generates electricity.

At least one exemplary embodiment is directed to the collisional fusion of at least two oppositely charged hydrogenated fluid streams, droplets, and/or mists.

At least one exemplary embodiment is directed to the collisional fusion of at least two charged fluids, where the collision results in the partial fusion of the two charged fluids creating a third element.

At least one exemplary embodiment is directed to the collisional fusion of at least two neutralized charged fluid streams, droplets, and/or mists.

Further areas of applicability of embodiments of the present invention will become apparent from the detailed description provided hereinafter. It should be understood that the detailed description and specific examples, while indicating exemplary embodiments of the invention, are intended for purposes of illustration only and are not intended to limit the scope of the invention.

### BRIEF DESCRIPTION OF THE DRAWINGS

Exemplary embodiments of the present invention will become apparent from the following detailed description, taken in conjunction with the drawings in which:

FIGS. 1A and 1B illustrates basic charge fluid production systems according to U.S. patent application Ser. No. 11/265,041 filed on 2 Nov. 2005;

FIG. 2 illustrates a charged fluid collisional system according to at least one exemplary embodiment of U.S. patent application Ser. No. 11/265,041 on 2 Nov. 2005;

FIG. 2A illustrates a schematic for a basic electrode arrangement for charging a fluid flow in accordance with at least one exemplary embodiment;

FIG. 3 illustrates the basic configuration for a charged fluid collisional system;

FIG. 4 illustrates a charged fluid production system;

FIG. 5 illustrates a charged fluid production and deflection system;

FIG. 6 illustrates at least one exemplary embodiment of a charged fluid collisional fusion system;

FIG. 7 illustrates a co-axial dual charged fluid flow production system;

FIG. 8 illustrates a multi-droplet charged fluid production system according to at least one exemplary embodiment;

FIG. 9 illustrates a multi-droplet charged fluid collisional system in accordance with at least one exemplary embodiment.

FIG. 10 illustrates angular collision of charged droplets in accordance with at least one exemplary embodiment;

FIG. 11 illustrates a fluid droplet collisional reactor in accordance with at least one exemplary embodiment;

FIG. 12 illustrates a coolant loop and electric generator in accordance to at least one exemplary embodiment;

FIG. 13 illustrates a fusion electric generation and coolant loop system in accordance with at least one exemplary embodiment;

FIG. 14 illustrates a fusion reactor and fuel delivery system in accordance with at least one exemplary embodiment;

FIG. 15 illustrates a single fluid oscillation system configured to generate charged droplets in accordance with at least one exemplary embodiment;

FIG. 16 illustrates a multi fluid oscillation system configured to generate charged droplets in accordance with at least one exemplary embodiment;

FIG. 17 illustrates a multi fluid oscillation system configured to generate charged droplets in accordance with at least one further exemplary embodiment;

FIG. 18 illustrates at least one exemplary embodiment including multiple charged droplets colliding with a relatively stationary hydrogenated fluid;

FIG. 19 illustrates a cross section of the system illustrated in FIG. 18; and

FIG. 20 illustrates a method of guiding a charged hydrogenated droplet, for example an aphron, against forces that would move the aphron away from a collisional path in accordance with at least one exemplary embodiment.

### DETAILED DESCRIPTION OF EXEMPLARY EMBODIMENTS OF THE PRESENT INVENTION

The following description of exemplary embodiment(s) is merely illustrative in nature and is in no way intended to limit the invention, its application, or uses.

Processes, methods, materials and devices known by one of ordinary skill in the relevant arts may not be discussed in detail but are intended to be part of the enabling discussion where appropriate (e.g., the processes and materials in “Principles of Plasma Discharges and Materials Processing”, Michael A. Lieberman, et al., ISBN 0-471-00577-0, 1994). For example the formation of electro-optic lenses and non-optical structures are discussed and many materials can be used with the methods and devices of exemplary embodiments (e.g., SiO₂, CaCO₃, TiO₂, Al₂O₃, SrTiO₃, MgF₂, LiF, CaF₂, BaF₂, NaCl, AgCl, KBr, KI, CsBr, CsI, Ge, ZnSe, ZnS, Ge/As/Se, GaAs, CdTe, MgO, Polycarbonate, Polystyrene, Polycarbonate, COC™, Acrylic (PMMA), based polymers, photoresist, silicon oil, Si, SiC, CaF, MgF, semiconductors, plastics, polymers, metals, other optical and non-optical materials, other materials that can be etched (e.g., wet, plasma), other materials that can be molded, equivalents, and other materials that one of ordinary skill in the relevant arts would know could be used with methods and devices of exemplary embodiments).

Additionally, the size of structures used in exemplary embodiments are not limited by any discussion herein (e.g., the sizes of structures can be macro (centimeter, meter, size), micro (micro meter), nanometer size and smaller).

Additionally, examples of electric and magnetic field generation device(s) are discussed, however exemplary embodiments are not limited to any particular device for generating electric and magnetic fields configured to manipulate charged fluid.

Additionally, discussion herein refers to hydrogenated fluid(s) (e.g., H2O, liquid H2, and other fluids containing hydrogen), that can be at least initially charged (e.g., could be neutralized later before collision) or has an aphron sheath or core that can be charged, and exemplary embodiments provide several examples of such fluids. However, the present invention is not limited to the mentioned fluids in the examples, and can be any fluid that can be charged (i.e. a + or − net charge) by either electron addition/removal or ion addition/removal. This includes solids that are heated to a fluid state, or gases that are cooled to a liquid state. Thus charged fluids of these substances can be collided to form higher elements as a byproduct. Some examples of common substances can be found in the Handbook of Chemistry and Physics (HPC) published by CRC Press (e.g. 75^{th} Edition, 1994, ISBN 0-8493-0475-X) provides the resistivity characteristics of many materials that are intended to lie within the scope of at least one exemplary embodiment. For example pg. 12-185, of the 1994 version of the HPC, lists the electrical resistivity of commercial metals and alloys, each of which can be put into liquid form, then manipulated via methods in accordance with at least one exemplary embodiment, with at least one method in accordance with at least one exemplary embodiment using resistivity values to estimate the net charge under the operating conditions.

### Exemplary Embodiment Summaries

Exemplary embodiments are provided for illustrative non-limiting purposes only.

The first exemplary embodiment is directed toward accelerating charged hydrogenated fluid into collisions of sufficient energy to initiate at least partial fusion of the collisional hydrogenated fluid, where one of the products of the collision is a product including an element higher in the periodic tables than at least one of the collided fluids, and where, optionally, the at least partial fusion heats a coolant loop which in turn generates electricity.

The second exemplary embodiment is directed to the collisional fusion of at least two oppositely charged hydrogenated fluid streams, droplets, and/or mists.

The third exemplary embodiment is directed to the collisional fusion of at least two neutralized charged fluid streams, droplets, and/or mists.

The fourth exemplary embodiment is directed to the collisional fusion of at least two dissimilar (e.g., a first stream of a fluid including element 1 and a second stream of a fluid including a molecule not containing element 1 and/or including element 2) charged fluid streams, droplets, and/or mists.

The fifth exemplary embodiment is directed to a fusion system wherein at least one initially charged fluid droplet or mass collides with a relatively stationary hydrogenated fluid, wherein the collision results in at least a few fusion related products.

The sixth exemplary embodiment is directed to a fusion system wherein the sheath or core of an aphron is charged while the hydrogenated portion is uncharged, with the optional ability of curing the sheath into solid form to reduce evaporation or charge droplet spray spreading.

### Charged Fluid Technology

The general description of the physics involved in charging fluid systems and several relationships that can be used to obtain estimates of the net charge on fluid streams and droplets to design systems in accordance with exemplary embodiments has been described in patent application Ser. No. 11/265,041 filed on 2 Nov. 2005, incorporated herein by reference in it's entirety.

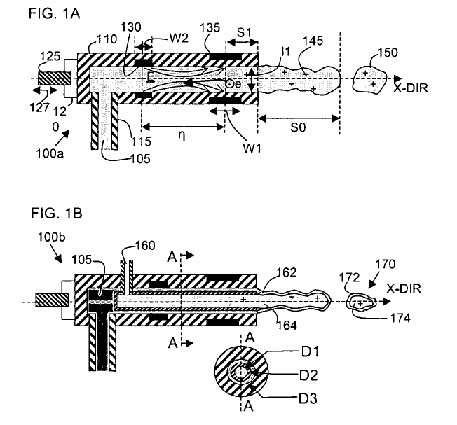

FIGS. 1A and 1B from Ser. No. 11/265,041 are used to illustrate calculation of the volumetric flow leaving charged fluid production devices or aphron production devices in accordance with at least one exemplary embodiment. FIG. 1A illustrates a charged fluid production system 100a. The fluid 105, injected via an intake channel 115 into reservoir 110, can have a certain conductivity σ. When an electric field E is applied across a portion of the fluid 105 the electrons and/or ions in the fluid 105 move in response. If the fluid 105 breaks into droplets 150 or a separate stream there is a net charge on the droplets 150 or separate stream. The electric field E in accordance with the first embodiment can be created by a voltage difference between electrodes (e.g., 130, 135) or an electrode built into the charged fluid production device 100a or aphron production devices 100b and the fluid reservoir 110 (or intake channel 115). A method that can be used to calculate the net charge is described next.

### First Sample Method for Calculating Net Droplet Charge

In this example there is an electric field E between electrodes 130 and 135. The center of the electrodes is spaced η in the X-direction and t½ in the Y direction where t1 is the thickness of the reservoir 110. The Electric field can be approximated by the difference of the voltages V₁₃₅ and V₁₃₀ of the electrodes 135 and 130 respectively divided by the distance η:

E=(V₁₃₅−V₁₃₀)/η=ΔV/η (4)

The electric field E drives a current, which as stated above, results in a net charge in any droplet formation. The net charge can be determined using the velocity of the fluid flow between electrodes (e.g., 130, 135). The current travels through the moving fluid until the fluid passes the last electrode. The net charge in the moving fluid will be related to the time Δt it takes the moving fluid to pass both electrodes (i.e. pass through the Electric Field E) and the current driven by the Electric field E. The current j can be expressed as:

j=σE=σ(ΔV/η)=\dot{N}ₑe, where (5)

j is the current density (amp/m³), σ is the conductivity (amp/m² Volt), E is the electric field (Volt/m) between electrodes, ΔV is the voltage difference between electrodes, η is the distance (m) between electrodes, \dot{N}ₑ (#electrons/m̂3 sec), and ‘e’ is an electron charge (e=1.6×10⁻¹⁹Coulomb/electron). The time it takes a fluid element to pass from one electrode to another can be expressed as:

Δt=η/v, where (6)

‘v’ is the velocity of the fluid through the reservoir 110, and η is the distance between centers of the electrodes (e.g., 130 and 135) in the X-direction. Solving for the total number of electrons that are driven in time Δt, we have:

$${N}_{e} = {\dot{N}}_{e} Δ t = \frac{σΔ V}{e η} \frac{η}{v} = \frac{σΔ V}{ev} \qquad ( 7 )$$

The charge density (# electrons/m³) will be:

$${N}_{d} = \frac{{N}_{e}}{1 sec * f} = \frac{σΔ V}{1 sec * f * {e}^{*} v} , \qquad ( 8 )$$

where

f is a disturbance frequency or the number of droplets/sec. Equation 8 provides an estimate of the net charge per droplet, assuming that f droplets are produced per second.

### Illustrative Example for Approximating the Charge on Each Droplet

For example assume that a shaking device (not shown) is attached to the charged fluid production device 100a (single flow device) via an attachment arm 125 connected to the reservoir 110 by an attachment 120. The shaking device can oscillate at varying amplitudes at varying frequencies. Suppose that the shaking device oscillates in the +/−X-dir with a frequency of f=100 Hz. Suppose also for this non-limiting example that the diameter (I1) of the reservoir is I1=1 mm or 1×10⁻³ m. Also that the voltage difference ΔV between the electrodes 135 and 130 is 500 Volts and that the electrodes are spaced η=10 mm or 1×10⁻² m. Now one can obtain the conductivity a from tables or the manufacturer. To obtain an estimate of the net charge on a droplet, the velocity of the fluid is needed. The velocity “v” can be calculated by comparing the pressure difference ΔP between the pressure of the fluid storage (not shown) Pₛ supplying the reservoir and the exit pressure Pₑ, which can be expressed as:

$${P}_{e} + \frac{1}{2} ρ {v}^{2} \approx {P}_{s} , \qquad ( 9 )$$

where Pₑ is the exit pressure

for example atmospheric pressure, Pₐₜₘ. Equation (9) can be solved for the velocity “v” as:

$$v = \sqrt{\frac{2 ( {P}_{s} - {P}_{atm} )}{ρ}} = \sqrt{\frac{2 Δ P}{ρ}} \qquad ( 10 )$$

substituting the expression for the velocity “v” into equation (8) one can solve for the charge per droplet as:

$${N}_{d} = \frac{{N}_{e}}{1 sec * f} = \frac{σ Δ V}{1 sec * e * f} \sqrt{\frac{ρ}{2 ( {P}_{s} - {P}_{atm} )}} \qquad ( 11 )$$

The pressure difference can be either set or the size of the droplets can be chosen and the pressure difference calculated from the size. If one assumes that a droplet is spherical in size the volume is:

$$V = \frac{4}{3} {r}^{3} π \qquad ( 12 )$$

Continuing the example, if one assumes just for the example that a droplet size is chosen to be 1 mm in diameter (1×10⁻³ m). Thus the volume, using equation (12) is 5.23×10⁻¹⁰ m³. If f=100 Hz, there will be approximately 100 droplets/sec. The volumetric flow rate β can be approximated by 100×5.23×10⁻¹⁰ m³/sec. To calculate the velocity needed one can use the desired volumetric flow rate β and the exit area Aₑ=r²ππ, where r=I½:

$$v = \frac{β}{{A}_{e}} = \frac{β}{{r}^{2} π} \qquad ( 13 )$$

Using (13) Aₑ=7.85×10⁻⁷ m², thus v=6.66×10⁻² m/s. For the example then the pressure difference is (using (9) or (10)) ΔP=0.5 ρv² for a particular density ρ value. Thus the fluid storage pressure can be set to Pₛ=Pₐₜₘ+ΔP to obtain the desired velocity fluid flow. Using all of the above information for this non-limiting example, and the conversion of 1CVolt=1J the charge number density (#electrons/m³) per droplet is approximated as:

$${N}_{d} = \frac{σ Δ V}{1 sec * f * e * v} = \frac{σ ( 500 Volts )}{( 1 sec ) ( 100 Hz ) ( 1.6 \times {10}^{- 19} C ) ( 6.66 \times {10}^{- 2} \text{m/s} )} , \qquad ( 14 )$$

where the conductivity can be plugged in to get the charge number density per droplet. Note that the conductivity of water varies depending upon dissolved solids and temperature (Light et al., Electrochemical and Solid State Letters, 8(1), E16-E19 (2005)). Thus various solids (e.g., NaCl) can be dissolved in the hydrogenated fluid to increase the net charge per droplet.

FIG. 1B illustrates an aphron production device 100b, that can be a charged aphron production device with the addition of electrodes 130a and 135a. Note that, as with the device illustrated in FIG. 1A, one electrode can be used and voltage biased against the outer reservoir 111 or the inner reservoir 161, without the need for two electrodes. As illustrated in FIG. 1B the aphron production device 100b flows an inner flow 160 into an inner reservoir 161, with an outer flow 105 flowing in an outer reservoir 111. The inner 164 and outer 162 fluid flows out the exit. Without a shaker the combined fluid flow (inner 164 and outer 162 fluid flow) will break up into droplets 170 with combined constituents forming in some cases a core 174 and a sheath 172. With a shaker (e.g., connected to 125), as discussed above with respect to the charged fluid production device 100a, a shaker frequency (e.g., f) along with chosen inner and outer fluid flows can result in predictable substantially uniform aphron production. Where the term aphron is intended to mean a mixed constituent droplet (e.g., a core 174 surrounded by at least one sheath 172) or mixed constituent stream (e.g., 162, 164).

The inner reservoir 164 can have an inner diameter D1, with a thickness bringing the outer reservoir inner diameter to D2. The outer reservoir has an outer diameter D3. The relationship between the fluid flows, shaker frequency, an aphron production can be approximated to be used in exemplary embodiments.

### An Example of Approximate Aphron Production

The inner 160 and outer 105 fluid flows pass through the exit areas defined by the diameters D1, D2, and D3. For this non-limiting example lets assume that the resultant droplet 170 has a core diameter of 1 mm, with a sheath volume of 3% by volume. The core diameter DC can be related to the core volume by:

$${V}_{c} = \frac{4}{3} {π ( \frac{{D}_{c}}{2} )}^{3} = 5.23 \times {10}^{- 10} {m}^{3} \qquad ( 15 )$$

The shell thickness of the sheath can be approximated by the difference between the inner sheath diameter Dₛᵢ and he outer sheath diameter Dₛₒ:

$${V}_{s} = \frac{4}{3} π [ {( \frac{{D}_{so}}{2} )}^{3} - {( \frac{{D}_{si}}{2} )}^{3} ] = \frac{1}{6} π [ ( {D}_{so}^{3} ) - ( {D}_{si}^{3} ) ] \qquad ( 16 )$$

For simplification if we assume that the inner sheath diameter Dₛᵢ is equal to the core diameter D_{c}, we can then calculate the outer sheath diameter Dₛₒ from our assumption of the sheath volume as:

$${[ \frac{6}{π} ( 0.1 \times {V}_{c} ) + ( {D}_{si}^{3} ) ]}^{\frac{1}{3}} = {[ \frac{6}{π} ( 5.23 \times {10}^{- 11} {m}^{3} ) + ( 1 \times {10}^{- 9} {m}^{3} ) ]}^{\frac{1}{3}} = 1.039 \times {10}^{- 3} m = {D}_{so} \qquad ( 17 )$$

The flow rate in the inner reservoir βᵢ and the flow rate in the outer reservoir βₒ can be related to the shaker frequency f; the inner and outer reservoir exits areas Aᵢ and Aₒ respectively; the inner flow velocity vᵢ; the outer flow velocity vₒ; the pressures of the inner and outer fluid storage vessels (not shown) Pᵢ and Pₒ respectively; and the volume of the core V_{c} and sheath volume Vₛ. For example the flow rates βᵢ and βₒ can be related directly to the shaker frequency f and the droplet volumes V_{c} and Vₛ as:

βᵢ=fV_{c} (18)

μₒ=fVₛ (19)

For example if one wishes to produce 100 aphrons per second, with the volume relationships mentioned above, then f=100 Hz, and equations (18) and (19) can be solve to obtain, βᵢ=5.23×10⁻⁸ m³/sec, and βₒ=1.57×10⁻⁹ m³/sec. Now one can use the exit areas to calculate the velocity of the inner vᵢ and the velocity of the outer vₒ fluid flow. For example the following relationships can be used:

βᵢ=vᵢAᵢ and (20)

βₒ=vₒAₒ (21)

The exit areas for the above described example, Aᵢ for the inner reservoir exit area, and Aₒ for the outer reservoir exit area, can be calculated to be, Aᵢ=ππᵢ²=7.85×10⁻⁷ m² and Aₒ=ππ(¼)(Dₛₒ²−Dₛᵢ²)=6.28×10⁻⁸ m². Using these values as an example one can calculate the velocity rates using equations 20 and 21 to get vᵢ=6.66×10⁻² m/s and vₒ=2.5×10⁻² m/s. The pressure difference between the exit pressure and the storage vessel pressure, associated with the calculated velocities, can be approximated by equation (10)

$$v = \sqrt{\frac{2 ( {P}_{s} - {P}_{atm} )}{ρ}} = \sqrt{\frac{2 Δ P}{ρ}} . ,$$

Thus the pressure of the storage vessels supplying the inner and outer fluid can be determined from equation (10) using the velocities (e.g., vᵢ and vₒ) and the outer and inner fluid densities respectively ρₒ and ρᵢ.

$$Δ P = \frac{{v}^{2}}{2} ρ \qquad ( 22 )$$

For example if we use silicon oil (e.g., silicon oil as described in U.S. Pat. No. 4,119,461) as the outer fluid and water as the inner fluid (ρᵢ=1000 Kg m³), we get ΔPᵢ=2.218 N/m² for the inner fluid reservoir and the outer fluid pressure can be calculated using the density of the particular silicone oil used.

Sample Collisional Configuration from Ser. No. 11/265,041

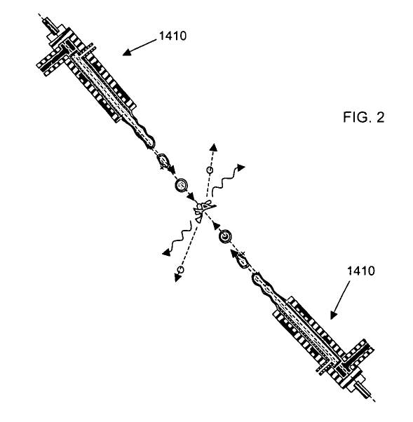

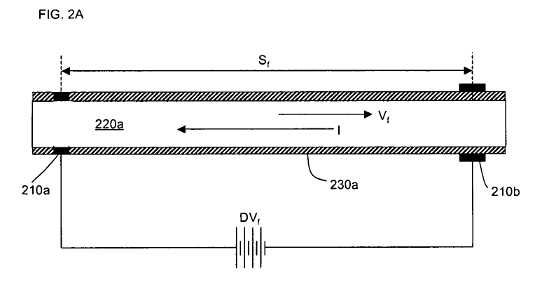

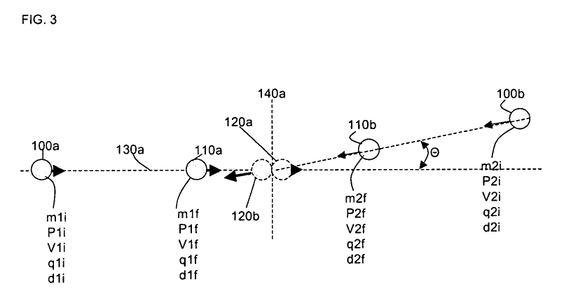

FIG. 2 illustrates an example of a pair of aphron production devices 1410 used to generate charged aphrons that can then be accelerated toward each other to initiate fusion. For example if the aphron cores of both are composed of charge deuterium water, the cores can be accelerated toward each other to study whether equation 3 can be satisfied and a fusion device constructed based upon charged accelerated aphrons. To aid in the combination one core can be negatively charged while the other is positively charged. The cores can be covered with a non-volatile sheath whom's surface tension and anti-evaporation criteria can keep the aphron together during acceleration. Such a device upon collision can result in gammas rays, and products, which can contain trace amounts of fusion byproducts. The collision area could be surrounded by a heat exchange chamber to drive an electric generator and produce electricity.

### First Example of Calculating Parameters of a Charged Fluid Fusion System

To simplify calculations we will initially assume that the hydrogenated fluid is water (H2O), with some electrolyte dissolved therein. We will also assume that we are using hydrogenated droplets, and that the size of the droplet is defined as that size containing 1 mole of H2O. Thus, we begin by calculating the mass of the droplet and the volume, as illustrated in equations (23)-(26).

$$\begin{matrix}1 mole of H 2 O = 6.02 \times {10}^{23} molecules & ( 23 ) \\ 1 mole of H 2 O = 18 \times {10}^{- 3} Kg & ( 24 ) \\ ρ V = mass = 18 \times {10}^{- 3} Kg = \frac{4}{3} π {r}^{3} ( 1000 {\text{Kg/m}}^{3} ) & ( 25 ) \\ r \approx 0.0163 m = 1.63 cm & ( 26 )\end{matrix}$$

Therefore for 1 mole of H2O we have a droplet of H2O with a 1.63 cm radius, and a mass of 18×10⁻³ Kg. For this example this droplet will be initially charged, accelerated to the designed kinetic energy (e.g., 0.22 MeV), then either left charged or neutralized (e.g., via an electron spray if droplet is charged +), then collided with another accelerated charged hydrogenated droplet, or colliding with a relatively stationary bath.

Now for this example we assume that the charged hydrogenated droplet crosses several voltage differences (e.g., provided by voltage potentials between hoop electrodes, through which the droplet passes) so that in general a kinetic energy of 0.22 Mev is achieved. Assuming a final kinetic energy of 0.22 MeV for each molecule in the water one can calculate the final velocity of one of the H2O molecules.

$$\begin{matrix}0.22 Mev ( 1.6 \times {10}^{- 19} \text{J/eV} ) = 3.52 \times {10}^{- 14} J & ( 27 ) \\ 3.52 \times {10}^{- 14} J = \frac{1}{2} {mv}_{f}^{2} ⇒ v = \sqrt{\frac{( 2 ) \cdot ( 3.52 \times {10}^{- 14} J )}{( 18 \cdot ( 1.67 \times {10}^{- 27} \text{Kg/proton} ) \text{Kg} )}} \approx 1.53 \times {10}^{6} \text{m/s} & ( 28 )\end{matrix}$$

Now there are many molecules in the charged droplet, however for this example we will want all of the molecules moving at the speed of equation 28. There are several methods to now calculate the charged needed on the droplet and the electric field needed (e.g., within the acceleration region due to the potential differences) to accelerate the charged droplet to speeds mirroring the speed of equation (28). For this example we will first assume a potential difference of 220,000 Volts along a distance of 1 meter providing an electric field (E=220,000 V/m) in accordance with equation (29).

$$\begin{matrix}E = Δ V / Δ s \approx \text{220,000 Volts} / 1 meter = \text{220,000 V/m} & ( 29 ) \\ {v}_{f}^{2} = {v}_{i}^{2} + 2 {a}_{s} Δ s ⇒ {a}_{s} \approx \frac{{v}_{f}^{2}}{2 Δ s} = \frac{( 1.53 \times {10}^{6} \text{m/s} )}{2 \cdot ( 1 m )} = 1.17 \times {10}^{12} {\text{m/s}}^{2} & ( 30 )\end{matrix}$$

Now we can use equation (30) to derive the acceleration needed within the 1 meter (Δs). The charge needed on the droplet can be obtained by comparing the forces as in equation (31).

qE=ma [symbol] nₑ(1.6×10⁻¹⁹)·(220000 V/m)=(18×10⁻³ Kg)(1.17×10¹² m/s²) (31)

Solving for nₑ, the number of electron equivalent charges, one obtains (see equation 32) a number close to the number of molecules in the droplet (6.02×10²³ molecules of H2O in 1 mole of H2O).

$${n}_{e} = \frac{{ma}_{s}}{eE} ⇒ {n}_{e} \approx \frac{( 18 \times {10}^{- 3} Kg ) ( 1.17 \times {10}^{12} {\text{m/s}}^{2} )}{( 1.6 \times {10}^{- 19} ) \cdot ( 220000 \text{V/m} )} = 5.98 \times {10}^{23} \qquad ( 32 )$$

To obtain a lower more reasonable number of electronic charges one can start with the desired number of charges and work backwards changing the initially assumed values. Thus repeated variations of some of the assumed values can be changed to accommodate a realistic configuration. The second example discussed below, starts with a realistic number of charges, then recalculates the other parameters.

### Second Example of Calculating Parameters of a Charged Fluid Fusion System

For the second example we will start with assuming that 0.1% of the molecules have a charge stripped, and keep the 1 mole size and mass of the hydrogenated fluid (H2O). Thus we have for this example nₑ≈6.02×10²⁰ electron charges. For this example lets increase the acceleration distance, Δs=100 m. Then equation 33 can be used to derive an approximate (e.g., in this case without relativistic corrections) acceleration value.

$${v}_{f}^{2} = {v}_{i}^{2} + 2 {a}_{s} Δ s ⇒ {a}_{s} \approx \frac{{v}_{f}^{2}}{2 Δ s} = \frac{{( 1.53 \times {10}^{6} \text{m/s} )}^{2}}{2 \cdot ( 100 m )} = 1.17 \times {10}^{10} {\text{m/s}}^{2} \qquad ( 33 )$$

Now one can use equation 34 to calculate the electric field across the entire 100 m acceleration region, needed to obtained the accelerations designed for:

$$E = \frac{{ma}_{s}}{{en}_{e}} ⇒ E \approx \frac{( 18 \times {10}^{- 3} Kg ) ( 1.17 \times {10}^{10} {\text{m/s}}^{2} )}{( 1.6 \times {10}^{- 19} ) \cdot ( 6.02 \times {10}^{20} )} = \text{2,186,461.79 V/m} \qquad ( 34 )$$

Note that although electrostatic accelerators have been inferred during the examples discussion (E field across entire acceleration region), a linear accelerator (linac, some of which are capable, if looped, to 1 GeV) can be used where a localized (between relevant electrodes) modest voltage can be seen by the accelerated droplet and accelerated to the desired velocity of 1.53×10⁶ m/s. In such a situation the acceleration length can be longer.

### Third Example of Calculating Parameters of a Charged Fluid Fusion System

Instead of using an electrostatic accelerator, one can use a linear accelerator where the region about a charged droplet sees a relatively constant electric field for the distance of acceleration. For example, if the charged droplet sees a localized electric field of 100,000V/m then the acceleration for the 0.1% charged hydrogenated droplet will be:

$$E = \frac{{ma}_{s}}{{en}_{e}} ⇒ a \approx \frac{( 1.6 \times {10}^{- 19} ) ( 100 , 000 \text{V/m} ) ( 6.02 \times {10}^{20} )}{( 18 \times {10}^{- 3} Kg )} = 5.35 \times {10}^{8} {\text{m/s}}^{2} \qquad ( 35 )$$

Now from equation (35) the acceleration distance can be calculated, as:

$${v}_{f}^{2} = {v}_{i}^{2} + 2 {a}_{s} Δ s ⇒ Δ s \approx \frac{{v}_{f}^{2}}{2 {a}_{s}} = \frac{{( 1.53 \times {10}^{6} \text{m/s} )}^{2}}{2 \cdot ( 5.35 \times {10}^{8} {\text{m}}^{2} \text{/s} )} = 2187.75 m \qquad ( 36 )$$

Thus, for the fusion reactor in accordance with the third example calculation, a 2.187 km acceleration portion can be used in conjunction with a linac configuration with a local electric field of 100,000 V/m. Note that in some configurations (e.g., acceleration distance <1 km) a vertical shaft could be used where gravitational free fall aids in keeping the droplet in the acceleration tube until impact.

The remaining considerations are: to calculate the charge fluid generator electrode voltage to produce the 0.1% charged hydrogenated droplet: addressing breakup concerns of the droplet (e.g., using an aphronated sheath to maintain droplet integrity), counteracting gravity with regards to the hydrogenated droplet in the accelerator region (e.g., using gradient magnetic field to levitate the droplet, or vertical shafts to reduce the gravitational effect), calculating the interaction length during collision (e.g., in the droplet on droplet case and the droplet on stationary pool case), and calculating the interaction time, to see if conditions satisfy Lawson's criteria (equation 3). Each of these features will be addressed by examples of exemplary embodiments.

### Example of Charging Hydrogenated Fluid to 0.1%

As discussed above with regards to FIGS. 1A and 1B, there are several methods for placing a net charge on the droplet and/or fluid. To accelerate charged hydrogenated fluid one can place a charge on the hydrogenated fluid and accelerate it in electric and/or magnetic fields. For example to charge a hydrogenated fluid by 0.1% by number one can place a voltage across the hydrogenated fluid driving a current. The current results in the movement of charges that carry the current, leaving a net charge in a portion of the hydrogenated fluid. Knowing the conductivity of the hydrogenated fluid, the voltage difference, and the time it takes a fluid element to pass between electrodes creating the voltage difference one can calculate the net charge in the passing fluid element.

For this example we will use FIG. 2A to illustrate the electrode placement attached to a channel (230a) for charging the fluid 0.1% or (0.001*6×10²³) electrons (assuming singular charging). We assume that the electrodes are placed a distance S_{f}; that the voltage across the electrodes (210a and 210b) is DV_{f}, that the fluid flows with a speed of V_{f}, and that there is a current I across the electrodes (210a, 210b).

The time for the fluid to go from electrode 210a and 210b, is expressed in equation 37:

$$Δ t = \frac{{S}_{f}}{{V}_{f}} , \qquad ( 37 )$$

where V_{f} is the flow velocity.

The portion of the time in equation 37 associated with one fluid element is expressed as in equation 38:

$$Δ {t}_{d} = \frac{1}{{f}_{d}} , \qquad ( 38 )$$

where f_{d} is the frequency of the number of droplets produced in a second. The total charge, Qₜ, that travels between electrodes 210a and 210b in time Δt can be expressed as in equation (39):

$${Q}_{t} = I Δ t = I \frac{{S}_{f}}{{V}_{f}} = ( \frac{{DV}_{f} A}{ρ {S}_{f}} ) ( \frac{{S}_{f}}{{V}_{f}} ) = \frac{{DV}_{f} A}{ρ {V}_{f}} = \frac{{DV}_{f} A}{( ρ f / A )} = \frac{{DV}_{f} {A}^{2}}{ρ f} \qquad ( 39 )$$

where the voltage across the electrodes DV_{f} can be expressed as in equation (40):

$${DV}_{f} = IR ⇒ I = \frac{{DV}_{f}}{R} = \frac{{DV}_{f}}{( ρ \frac{{S}_{f}}{A} )} = \frac{{DV}_{f} A}{ρ {S}_{f}} ; \qquad ( 40 )$$

and where the volumetric flow rate f can be expressed as (41):

$$f = {V}_{f} A = {NV}_{d} ⇒ {V}_{f} = \frac{f}{A} , \qquad ( 41 )$$

where A is the cross sectional area of the channel 230a, N is the number of droplets per second, and V_{d} is the volume per droplet.

The charge per droplet can be expressed as in equation (42):

$${Q}_{td} = ( \frac{{DV}_{f} {A}^{2}}{ρ f} ) \frac{1}{{f}_{d}} = ( \frac{{DV}_{f} {A}^{2}}{ρ {NV}_{d}} ) \frac{1}{{f}_{d}} = {N}_{e} e , \qquad ( 42 )$$

where Nₑ is the number of charges in a droplet, and e is an electric charge of 1.6×10⁻¹⁹ Coulomb.

Using the given values of 1 mole of H2O per droplet (N_{H2O}=6.02×10²³ molecules); the mass of a single droplet of 18×10⁻³ Kg; a droplet radius of r=1.63×10⁻² m; the droplet frequency of f_{d}=100 Hz, volume v_{d} of a single droplet of v_{d}=(4π/3)(1.63×10⁻² m)³≈18.13×10⁻⁶ m³; A≈π(1×10⁻² m)²=1×10⁻⁴ πm²; and using a charged % of Qₜ=0.1% we get a net charge of per entire droplet of:

Q_{td}=0.001*N_{H2O}e=(6.02×10²⁰)(1.6×10⁻¹⁹ C)=96.32 C, (43)

Solving for the voltage between electrodes, DV_{f}, one gets:

$${Q}_{td} = \frac{{DV}_{f} {A}^{2}}{ρ {NV}_{d} {f}_{d}} ⇒ {DV}_{f} = \frac{{Q}_{td} ρ {NV}_{d} {f}_{d}}{{A}^{2}} = \frac{( 96.32 C ) ( 100 \text{/} sec ) ( 18.13 \times {10}^{- 6} {m}^{3} ) ( 100 Hz )}{{( π \times {10}^{- 4} {m}^{2} )}^{2}} ρ = 5.56 \times {10}^{8} ρ \qquad ( 44 )$$

Thus, as expected the electrode voltage will depend upon the resistivity. For example pure water is a poor conductor with a resistivity of ρ_{H}_{₂}_{O}≈2.5×10⁵ Ωm, at 20° C., at 1 atm. Using this value of the resistivity results in an electrode voltage of (using (44)) DV_{f}=1.39×10¹⁹ Volts, an unrealistic value. Thus, electrolytes or any other substances can be added to pure water to provide a resistivity that result in a more realistic electrode voltage. For example, adding about 80 g/liter provides about ρ≈0.1 Ωm, adding about 100 g/liters of HCl provides about ρ≈0.01 Ωm, adding about 100 g/liters of NaOH provides about ρ≈0.01 Ωm, and seawater having a salinity of 30,000 ppm provides about ρ≈0.3 Ωm. The solubility of various inorganic and organic solutes providing a reduced resistivity can change with temperature and with the particular solute, for example at 20° C., the solubility of KI is 144 g/100 mL in H2O; the solubility of KCl is 34 g/100 mL in H2O; the solubility of NaCl is 36 g/100 mL in H2O; the solubility of NaHCO₃ is 9.6 g/100 mL in H2O; the solubility of NaOH is 109 g/100 mL in H2O; and MgSO4-7H2O is 26 .g/100 mL in H2O.

Using a value of ρ≈0.01 Ωm, provides an electrode voltage of (using (44)) DV_{f}≈5.56×10⁶ Volts. In general to avoid arcing in 1 atm, a voltage less than 25 Volts/per thousandths of an inch (a mil) is needed. Now we can use 5.56×10⁸ Volts to determine the minimum electrode spacing of about:

$$\frac{5.56 \times {10}^{6}}{25 \text{/} mil} = 222400 mil \approx 222.4 inches = 5.65 m \qquad ( 45 )$$

if the electrodes are exposed openly to the air. Now if we use a more “salty” mixture, for example NaCl dissolved in H2O to a level the same as the Great Salt Lake, say about 230,000 mg/Liter of NaCl results in about ρ≈6×10⁻⁵ Ωm, which in turn results in DV_{f}=3.34×10⁴ Volts, which results in roughly 3.4 cm spacing of the electrodes.

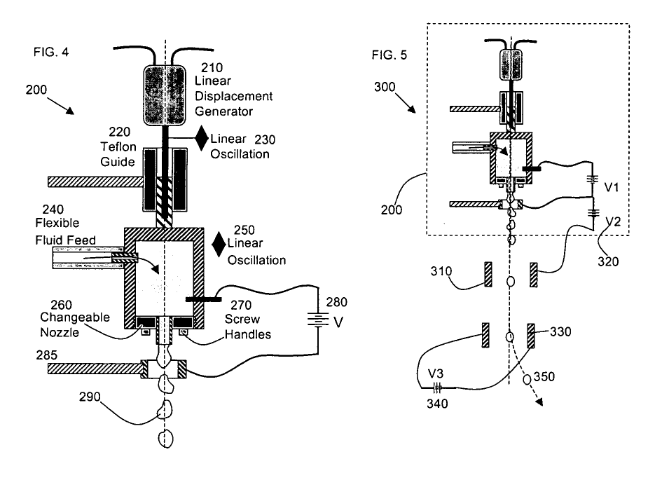

In experiments performed (for an example experimental configuration 300 see FIGS. 4 and 5, with an associated charged fluid generation apparatus 200), 10 g/liter surfactant of sodium dodecylbenzenesulfonate (NaDBS) was added to distilled water to provide an aqueous solution that has a large surface tension and increased conductivity. The electrode voltage difference V1, was about 700 Volts with a spacing of about 15 mm for an electric field of about 46666 Volts/m. The flow rate was about 70 cc/min which converts to 1.16×10⁻⁶ m³/sec from a tube with an exit area of about 6.18×10⁻⁷ m², resulting in an exit flow velocity of about 1.87 m/sec. To determine the charge per droplet a deflection voltage, V3 (340), of 3000 Volts was applied deflecting the charged droplets 350 (of about 1 mm diameter) horizontally 10 mm a vertical distance of 136 mm from the tube exit, resulting in a calculated net charge per droplet of about 4.6×10⁻⁴ C. Optionally an acceleration voltage (V2, 320) can be applied between the electrode 310 and the deflection plates 330. The volume per droplet is about 5.23×10⁻¹⁰ m³, for a mass per droplet of about 5.23×10⁻⁷ Kg. Using a final velocity v_{f}, of about 1.53×10⁶ m/s for each molecule of H2O, a linac accelerator voltage of 500,000 Volts/m, one obtains the acceleration of 4.4×10⁸ m/s², and an acceleration distance of about 2.66 km for fusion.

The non-limiting example of a charged fluid generation apparatus 200 is illustrated in FIG. 4, and includes a flexible tube 240 which feeds the fluid to be charged into a chamber and out through a changeable nozzle 260 that can have screw handles (e.g., which can be used to screw in the changeable nozzle 260). The fluid flowing out of the changeable nozzle 260 can pass through an electrode hoop 285, which can have a voltage difference V (280) with the fluid in the chamber resulting in a charged fluid droplet when the fluid stream breaks into charged droplets 290. To produce uniform droplets the chamber can be connected to a linear displacement generator 210, producing a linear oscillation 230, which can be coupled to the chamber resulting in a linear oscillation of the chamber 250. The linear oscillation 250 can result in uniform oscillations in the fluid flow resulting in uniform droplet formation. Thus the size of the droplet can be determined by the linear oscillation 250 frequency and fluid flow rate. In the example shown the connection between the linear displacement generator 210 can be connected via an arm through a Teflon guide 220 to facilitate vertical oscillations, of course other various configurations can be made within the scope of at least one exemplary embodiment.

### Example of Droplet Instability Prevention/Reduction

When a charged droplet is created, the net charges in the droplet tend to stretch and pull the droplet apart. If the net charge is large enough then the one droplet will break into many as discussed in the background section (“spray stability problem”). One method of reducing the effect is to surround the charged hydrogenated fluid with a sheath with large surface tension. In at least one example the sheath is curable (e.g., UV curable) so that the sheath becomes solid keeping the droplet together and adding in the reduction of evaporation. Although in some examples evaporation is desired (e.g., using a charged fluid to initiate high pressure plasma).

### Example of Droplet Path Stability

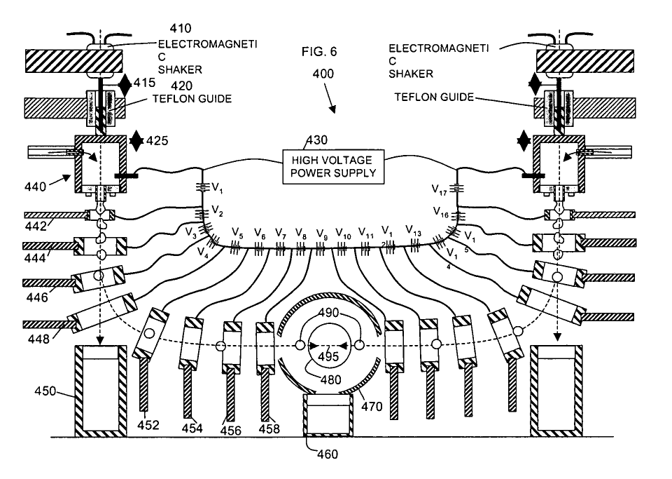

The charged droplets can be accelerated so that upon collision fusion products are produced. To keep the droplet along a stable path during its acceleration (e.g., along a collisional path of 2+km) several methods can be used. First a solidifying UV curable sheath can be used around a charged hydrogenated yoke as discussed above, to remove evaporation considerations. Then the charged hydrogenated fluid droplet can be accelerated along a collisional path. For example FIG. 6 illustrates an example a charged droplet (note that other fusion types can occur and thus the droplets can contain helium or other fusionable fuel, instead of hydrogen) collisional apparatus 400, which includes the collision of two charged droplets accelerated toward collisional fusion.

One method of supporting (counteracting) gravity along the acceleration path is to have the path along the gravitation vector (e.g., a radial tunnel toward the Earths center) or a force to counteract any force (e.g., gravity) seeking to pull the charged droplet away from the acceleration path. In non-vertical acceleration paths, where gravitational concerns play a role, electric and magnetic fields can be used. For example an electrostatic or lineac acceleration potential can accelerate oppositely charged droplets toward each other while a gradient magnetic field, dH/dz, perpendicular to the acceleration path can be used to create a gradient magnetic force, F_{DH}, dependent upon the magnetic susceptibility, χ, of the charged droplets, that can be used to balance the gravitational attraction of the droplet to the Earth, which can be expressed as:

$${F}_{DH} = {V}_{χ} H \frac{d H}{d z} = mg ⇒ η ≡ H \frac{d H}{d z} = \frac{mg}{{V}_{χ}} \qquad ( 46 )$$

Where V is the volume of the charged droplet. For water (diamagnetic), the volume magnetic susceptibility, in Si units, is −9.04×10⁻⁶.

Another expression for the minimum criteria for diamagnetic levitation is:

$$B \frac{d B}{d z} = {μ}_{0} ρ \frac{g}{χ} , \qquad ( 47 )$$

where:

As stated χ is the magnetic susceptibility

ρ is the density of the material

g is the local gravitational acceleration (−9.8 m/s² on Earth)

μ₀ is the permeability of free space

B is the magnetic field

$$\frac{d B}{d z}$$

is the rate of change of the magnetic field along the vertical axis Assuming ideal conditions along the z-direction of a solenoid magnet:

$$Water levitates at B \frac{d B}{d z} >> 1400 {T}^{2} \text{/} m \qquad ( 48 )$$

$$Graphite levitates at B \frac{d B}{d z} >> 375 {T}^{2} \text{/} m \qquad ( 49 )$$

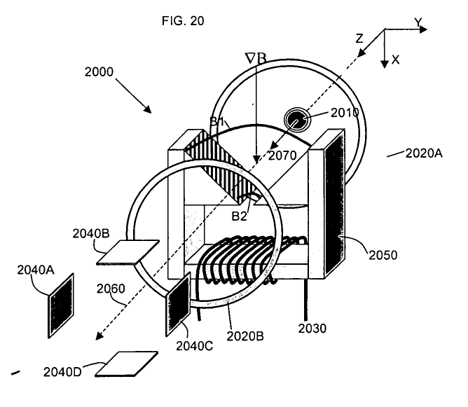

Thus designing a magnetic guidance system that satisfies at least equation (48) is an example of at least one system for guiding the charged hydrogenated droplets to the collisional chamber. Additionally, as mentioned previously, a sheath can surround the hydrogenated droplet. The sheath can include a material that requires a smaller gradient magnetic field (e.g., graphite, (49)). For example FIG. 20 illustrates a method of guiding a charged aphron (i.e., charged hydrogenated droplet with sheath). A central core 2050 (e.g. of iron) can be surrounded by a coil of wires 2030. When a current passes through the wires 2030 a magnetic field B1 can be generated. The “V” shaped end of the core 2050 varies the magnetic field in the X-direction. The number of loops of wire 2030 per meter “n”, and the current “I”, determine the magnetic field “B” as stated in equation (50), where n=4.0×10³/m, and I=2 amps:

B=μ₀nI=(12.57×10⁻⁷ Tm/A)(4.0×10³ m⁻¹)(2 amp)=1.0×10⁻² T

As mentioned previously instead of using a device to counteract gravity one can use a vertical shaft in the gravity direction with slight path corrections obtained by using a combination of electric and/or magnetic fields.

To calculate interaction length the velocity of a droplet can be determined or calculated before collision, and a sopping distance calculated in the medium (e.g., stationary medium 1930). The stopping distance can serve as an interaction length.

The interaction length can be used to calculate an interaction time, which can then be used to calculate whether fusion criteria is achieved.

### First Exemplary Embodiment

The first exemplary embodiment is directed toward accelerating charged hydrogenated fluid into collisions of sufficient energy to initiate at least partial fusion of the collisional hydrogenated fluid, where one of the products of the collision is a product including an element higher in the periodic tables than at least one of the collided fluids, and where, optionally, the at least partial fusion heats a coolant loop which in turn generates electricity.

### Second Exemplary Embodiment

The second exemplary embodiment is directed to the collisional fusion of at least two oppositely charged hydrogenated fluid streams, droplets, and/or mists.

### Third Exemplary Embodiment

The third exemplary embodiment is directed to the collisional fusion of at least two neutralized charged fluid streams, droplets, and/or mists.

### Fourth Exemplary Embodiment

The fourth exemplary embodiment is directed to the collisional fusion of at least two dissimilar (e.g., a first stream of a fluid including element 1 and a second stream of a fluid including a molecule not containing element 1 and/or including element 2) charged fluid streams, droplets, and/or mists.

### Fifth Exemplary Embodiment

The fifth exemplary embodiment is directed to the collisional fusion system where a charged fluid streams, droplets, and/or mists are directed toward an essentially relatively stationary hydrogenated fluid reservoir.

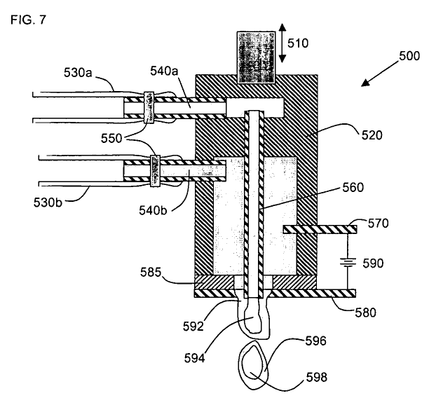

FIG. 7 illustrates a method of generating aphrons, having a sheath 596 and a yoke 598. The yoke is fed by an inner stream 540a, and the sheath is fed by an outer stream 540b. A charge can be placed on the aphrons via a voltage difference 590 between electrodes 570 and 580. The stream can be fed via tubes 530a and 530b, and to generate uniform droplet sizes the unit 500 can be shaked 510.

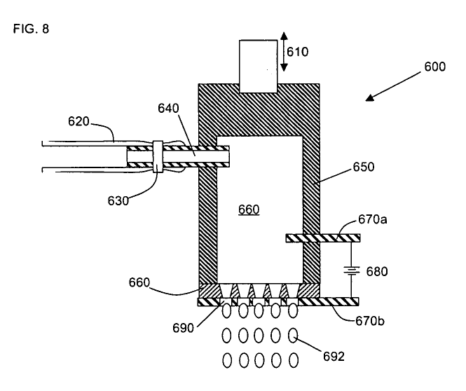

FIG. 8 illustrates a method/device 600 for generating a stream of charged droplets 692, by similar intakes and shaking as described for FIG. 7.

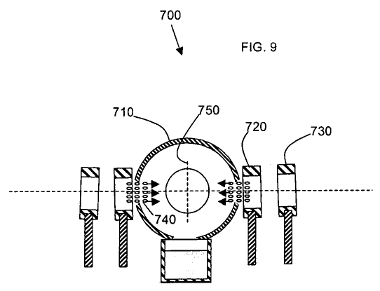

FIG. 9 illustrates collisions of a mist or group of droplets 740, where the charged droplets can be accelerated by various voltaged electrodes 720, 730.

FIG. 10 illustrates a collision of charged droplets 1010, 1020, with a resultant products 1040, 1050.

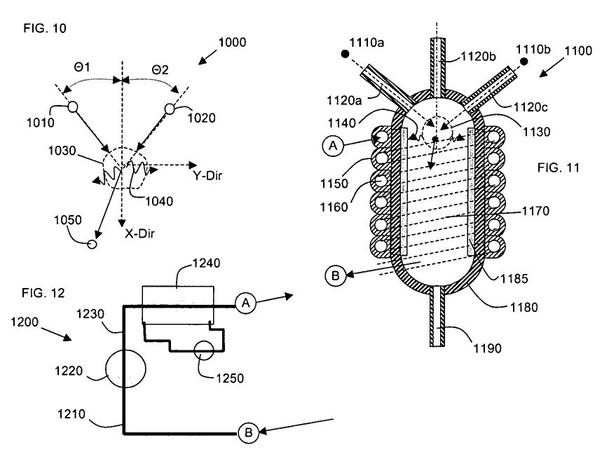

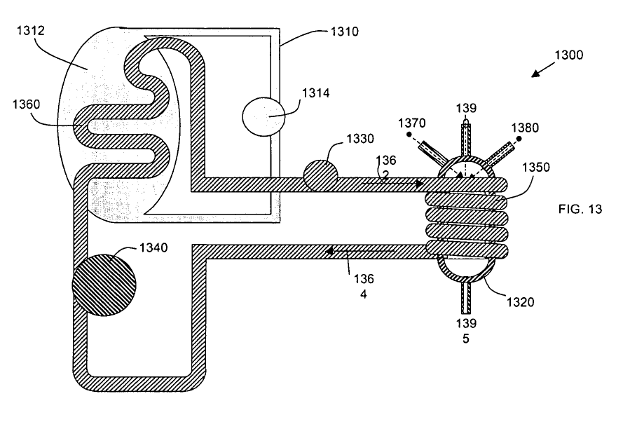

FIGS. 11 and 12 illustrate a power generation system based upon the collisional fusion system 1100. Cooling and heat transfer coils 1160 carry heated water to a generating system 1200, where a heat exchange system 1240 heats a secondary loop and an electric generator 1250. The system can be pumped 1220.

FIG. 1300 illustrates another schematic of the systems illustrated in FIGS. 11 and 12.

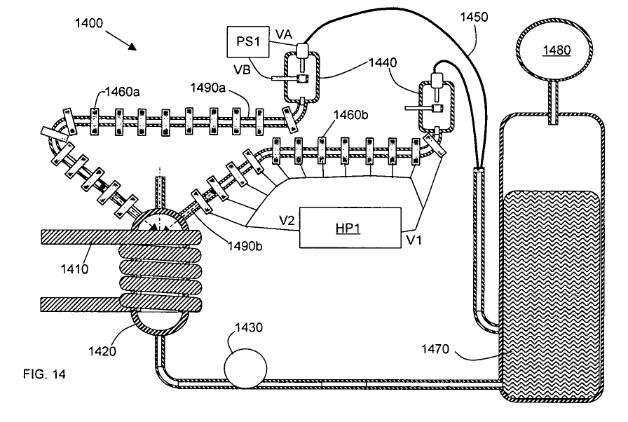

FIG. 14 illustrates a two collisional fusion system, where charged fluid generators 1440, PS1, VB and BA, are guided to a collision chamber 1420, by electrodes 1460a, 1490a, 1490b, and 1460b. A high voltage system HP1 can place a voltage across the electrodes. A heat exchange pipe 1410 transfers heat to a generator system, the unreacted products can be drained via a pump 1430 into storage system for reuse.

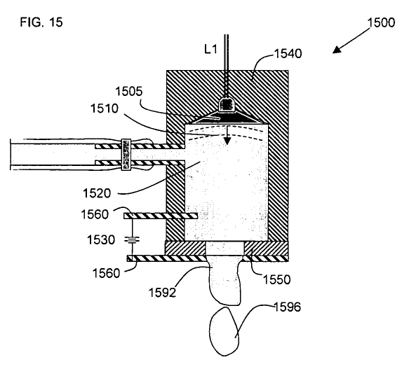

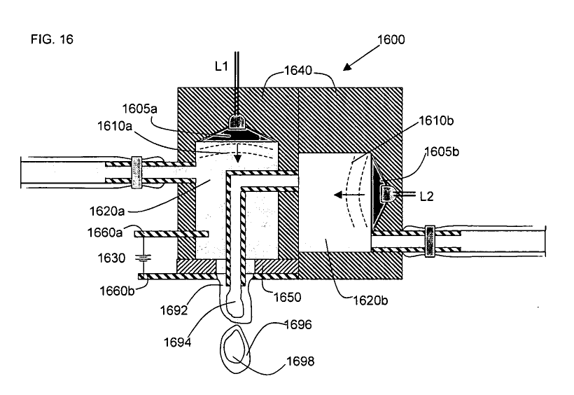

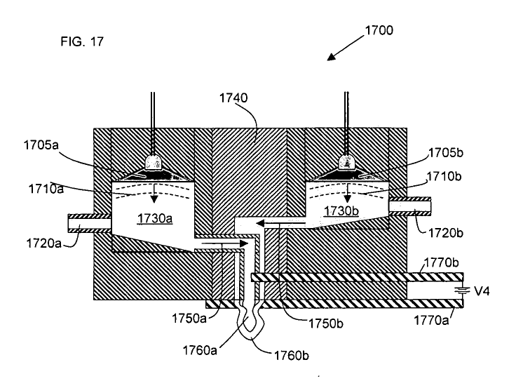

FIGS. 15-17 illustrate various methods of charged fluid generation and/or aphron generation.

FIG. 18 illustrates an exemplary embodiment 1800 where charged fluid droplet (e.g., also can be aphrons) collide with a relatively slower (e.g., stationary) medium (e.g., hydrogenated fluid), with feed pipes 1840 and 1850, and heat exchange pipes 1860 and 1870.

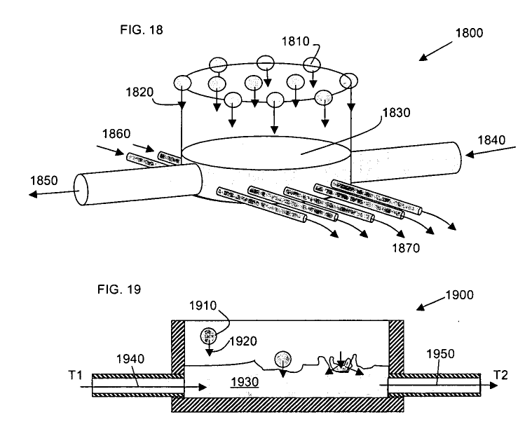

FIG. 19 illustrates the collision process of FIG. 18.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. A method of fusion generation:
accelerating a first charged fluid mass to a first energy, wherein the first charged fluid mass includes a hydrogenated fluid;
accelerating a second charged fluid mass to a second energy, wherein the second charged fluid mass includes a hydrogenated fluid; and
colliding the first charged fluid mass with the second charged fluid mass, and wherein products of the collision includes fusion products.

2. The method according to claim 1, wherein the first charged fluid mass has a charge opposite to the second charged fluid mass.

3. The method according to claim 1, wherein before the colliding step at least one of the first charged fluid mass and the second charged fluid mass is neutralized.

4. The method according to claim 1, wherein at least one of the first charged fluid mass and the second charged fluid mass is a mass in a charged fluid mist or stream.

5. The method according to claim 1, wherein at least one of the first charged fluid mass and the second charged fluid mass is at least one of a sheath and a yoke of an aphron.

6. The method according to claim 5, wherein the yoke and sheath are differently charged.

7. The method according to claim 1, further comprising:
performing the colliding step in a reaction chamber and cooling the reaction chamber with a coolant heat transfer loop, wherein a fluid in the coolant heat transfer loop becomes a superheated fluid.

8. The method according to claim 7, further comprising:
directing the superheated fluid into an electricity generating turbine to generate electricity.

9. The method according to claim 8, further comprising:
condensing superheated fluid leaving the generating turbine; and
directing at least a first portion of the condensed fluid into a charged fluid generator, which generates a new charged fluid mass.

10. An apparatus for fusion comprising:
a first guiding section;
a second guiding section; and
a reaction chamber, wherein the first guiding section is configured to direct an accelerated first charged fluid mass into the reaction chamber, wherein the first charged fluid mass includes a hydrogenated fluid, wherein the second guiding section is configured to direct an accelerated second charged fluid mass into the reaction chamber, wherein the second charged fluid mass includes a hydrogenated fluid, and wherein the first charged fluid mass collides with the second charged fluid mass wherein the collision results in fusion products.

11. The apparatus according to claim 10, wherein the first charged mass has a charge opposite to the second charged mass.

12. The apparatus according to claim 10, wherein at least one of the first charged fluid mass and the second charged fluid mass is neutralized before colliding.

13. The apparatus according to claim 10, wherein at least one of the first charged fluid mass and the second charged fluid mass is a mass in a charged fluid mist or stream.

14. The apparatus according to claim 10, wherein at least one of the first charged fluid mass and the second charged fluid mass is at least one of a sheath and a yoke of an aphron.

15. The apparatus according to claim 14, wherein the yoke and sheath are differently charged.

16. The apparatus according to claim 10, further comprising:
a reaction chamber, wherein the colliding of the first and second charged fluid mass occur in the reaction chamber; and
a coolant heat transfer loop, wherein the reaction chamber is cooled by the coolant heat transfer loop, wherein a fluid in the coolant heat transfer loop becomes a superheated fluid.

17. The apparatus according to claim 16, further comprising:
a generator system, wherein the superheated fluid is directed into generator system to generate electricity.

18. The apparatus according to claim 17, further comprising:
a condensing region, wherein the superheated fluid leaving the generating turbine is condensed in the condensing region, wherein at least a first portion of the condensed fluid is directed into a charged fluid mass generator, which generates a new charged fluid mass.

19. A method of fusion generation:
accelerating a first charged fluid mass to a first energy, wherein the first charged fluid mass includes a hydrogenated fluid; and
colliding the first charged fluid mass with a second charged fluid mass, wherein the second charged fluid mass includes a hydrogenated fluid, and wherein products of the collision includes fusion products.

20. The method according to claim 19, wherein the first charged fluid mass is a charged fluid droplet.
